(19) United States
(12) Patent Application Publication
(10) Pub. No.: US 2026/0155442 A1
(43) Pub. Date: Jun. 4, 2026

(54) ELECTROLYTE SOLUTION AND LITHIUM-ION BATTERY

(71) Applicant: ZHUHAI COSMX BATTERY CO., LTD., Zhuhai (CN)

(72) Inventors: Yingdi MU, Zhuhai (CN); Hai WANG, Zhuhai (CN); Suli LI, Zhuhai (CN)

(73) Assignee: ZHUHAI COSMX BATTERY CO., LTD., Zhuhai (CN)

(21) Appl. No.: 19/125,263

(22) PCT Filed: Feb. 1, 2024
(86) PCT No.: PCT/CN2024/075313

§ 371 Date: Apr. 28, 2025

(30) Foreign Application Priority Data
Jan. 4, 2023 (CN) 202310009845.6

(51) Int. Cl. H01M 10/0567; H01M 4/36; H01M 4/48; H01M 4/525; H01M 4/587; H01M 10/0525; H01M 10/0568; H01M 10/0569; H01M 10/42

(52) U.S. Cl. CPC H01M 10/0567; H01M 4/364; H01M 4/483; H01M 4/525; H01M 4/587; H01M 10/0525; H01M 10/0568; H01M 10/0569; H01M 10/4235; H01M 2300/004

(57) ABSTRACT

Disclosed are an electrolyte solution and a lithium-ion battery. The electrolyte solution includes a first additive, a second additive, and a third additive; the first additive includes a silane compound; the second additive includes a polycyclic compound; the third additive includes lithium difluoro(oxalato)borate. Through synergistic interactions between additives, the electrolyte solution enhances cell and safety performance while maintaining long cycle life and low-expansion performance.

### CROSS-REFERENCE TO RELATED APPLICATIONS

This application is the National Stage of International Application No. PCT/CN2024/075313, filed on Feb. 1, 2024, which claims priority to Chinese Patent Application No. CN202310009845.6, filed on Jan. 4, 2023. All of the aforementioned applications are incorporated herein by reference in their entireties.

### TECHNICAL FIELD

The present application relates to the field of lithium-ion battery technology, and in particular to an electrolyte solution and a lithium-ion battery.

### BACKGROUND

In recent years, lithium-ion batteries have been widely used in fields such as smartphones, tablets, wearable devices, power tools, and electric vehicles. With the expanding applications of lithium-ion batteries, consumer demands for their operational environments and performance requirements have continuously increased. This necessitates that lithium-ion batteries can balance a long lifespan, high/low-temperature performance, and high safety simultaneously.

Currently, lithium-ion batteries pose safety risks during operation. For example, under extreme conditions such as sustained high-temperature exposure, serious safety incidents such as fires or even explosions may occur. The main causes of these issues include: structural instability of active materials under high-temperature and high-voltage conditions; and exothermic reactions between electrolyte solution and lithiated graphite, releasing a large amount of heat, leading to continuous temperature rise within the cell, which ultimately triggers thermal runaway of the cell.

To overcome the aforementioned technical problems, there is an urgent need to develop lithium-ion batteries with high safety and high-voltage performance. Currently, the main approach involves adding flame retardants (e.g., trimethyl phosphate) to the electrolyte solution to enhance battery safety. However, the use of these flame retardant additives often leads to degrading battery performance and drastically shortens cell cyclability. Therefore, how to develop lithium-ion batteries that can achieve high safety and high-voltage without affecting the battery's electrochemical performance has become an urgent technical problem to be solved.

### SUMMARY

Objectives of the present application are to provide an electrolyte solution and a lithium-ion battery. The high-voltage lithium-ion battery is designed to exhibit excellent electrochemical performance, long cycle life, and high safety performance simultaneously.

To achieve the above-mentioned objectives, the present application provides the following technical solutions.

According to a first aspect, an electrolyte solution is provided, including an organic solvent, a lithium salt, a first additive, a second additive, and a third additive;
the first additive includes a silane compound;
the second additive includes a polycyclic compound; and
the third additive includes lithium difluoro(oxalato)borate.

According to a second aspect, a lithium-ion battery is provided, including a positive electrode plate, a negative electrode plate, a separator disposed between the positive electrode plate and the negative electrode plate, and the electrolyte solution according to the first aspect; a negative active material of the negative electrode plate includes a silicon-based material.

The beneficial effects of the present application over conventional technology are as follows.

Firstly, the electrolyte solution of the present application effectively enhances cell and safety performance while balancing long cycle life and low expansion performance through the synergistic effect between these additives. Specifically, the combination of the first additive (silane compound) and the second additive (polycyclic compound) can form a thicker and more stable SEI (Solid Electrolyte Interphase) protective film on the surface of the negative electrode through cross-linking when added in a specific proportion. This film prevents the electrolyte solution from being reduced on the negative electrode surface, thereby reducing heat release from side reactions and mitigating the problem of increased cycling expansion caused by the silicon-based negative electrode, thus enhancing the safety performance and long cycle life of the battery. Furthermore, the introduction of the third additive (lithium difluoro(oxalato)borate) enables the combination of the three types of additives forming a more flexible composite protective film on the negative electrode, further enhancing the safety performance of the cell.

Secondly, through the synergistic effect between the electrolyte solution and the negative electrode material, the lithium-ion battery with a silicon-based negative electrode prepared by the present application can effectively improve the safety performance of the cell while maintaining long cycle life and low-temperature performance.

### DETAILED DESCRIPTIONS OF THE EMBODIMENTS

Implementations of the present application are described in detail below. It should be understood that the implementations described herein are intended for illustration and explanation only and are not intended to limit the present application.

Unless otherwise defined, all scientific and technical terms used in the present application have the same meaning as commonly understood by those skilled in the art.

According to a first aspect, an electrolyte solution is provided, including an organic solvent, a lithium salt, a first additive, a second additive, and a third additive;
the first additive includes a silane compound;
the second additive includes a polycyclic compound; and
the third additive includes lithium difluoro(oxalato)borate.

The present study reveals that the combined use of the first additive (silane compound), the second additive (polycyclic compound), and the third additive (lithium difluoro(oxalato)borate) demonstrates dual synergistic effects: on one hand, forming a thicker and more stable SEI protective film on the negative electrode surface through cross-linking, which effectively prevents the electrolyte solution from being reduced on the negative electrode surface, reduces heat release from side reactions, mitigates the problem of increased cycling expansion caused by the silicon-based negative electrode, thereby significantly enhancing the safety performance and long cycle life of the battery; on the other hand, forming a more flexible composite protective film on the negative electrode, further enhancing the safety performance of the cell. Through the synergistic effect of the three types of additives, the cell and safety performance are effectively improved, while maintaining long cycle life and low-expansion performance.

In some embodiments, the silane compound of the first additive includes tetravinylsilane. Optimizing the type of silane compound further enhances the synergistic effects when the first additive is combined with the other two additives, thereby providing further improvements in both cell and safety performance.

In some embodiments, the polycyclic compound of the second additive includes at least one compound selected from Formula T1 to Formula T8:

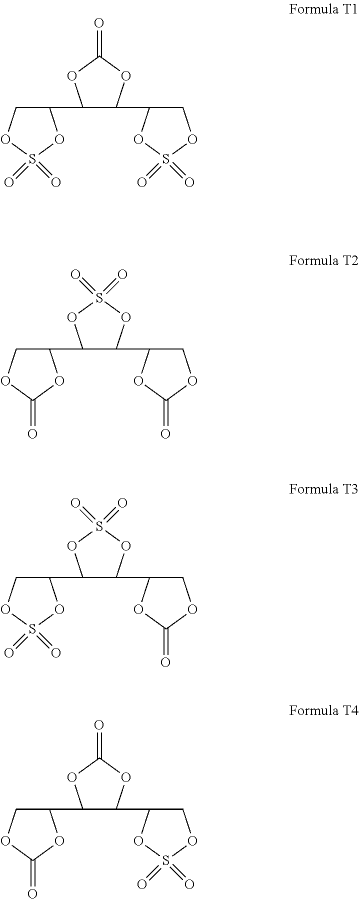 [SMILES: O=C1OC(C2COS(=O)(=O)O2)C(C2COS(=O)(=O)O2)O1 ; O=C1OCC(C2OS(=O)(=O)OC2C2COC(=O)O2)O1 ; O=C1OCC(C2OS(=O)(=O)OC2C2COS(=O)(=O)O2)O1 ; O=C1OCC(C2OC(=O)OC2C2COS(=O)(=O)O2)O1]

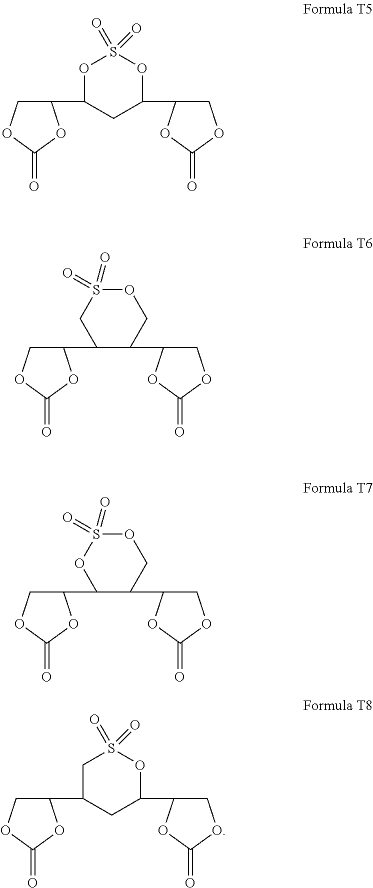 [SMILES: O=C1OCC(C2CC(C3COC(=O)O3)OS(=O)(=O)O2)O1 ; O=C1OCC(C2COS(=O)(=O)CC2C2COC(=O)O2)O1 ; O=C1OCC(C2COS(=O)(=O)OC2C2COC(=O)O2)O1 ; O=C1OCC(C2CC(C3COC(=O)O3)OS(=O)(=O)C2)O1]

By optimizing the type of polycyclic compound, the synergistic effects between the polycyclic compound and the first additive can be further enhanced, promoting stable SEI film formation on the negative electrode surface. This effectively prevents electrolyte solution from being reduced on the negative electrode surface, reduces heat release from side reactions, and mitigates cycling expansion caused by silicon-based negative electrode, thereby enhancing battery safety and long cycle life.

In some embodiments, the addition amount of the first additive ranges from 0.2 wt % to 1 wt % of a total mass of the electrolyte solution (for example, 0.2 wt %, 0.3 wt %, 0.4 wt %, 0.5 wt %, 0.6 wt %, 0.7 wt %, 0.8 wt %, 0.9 wt %, 1 wt %, or any range composed of any two of the aforementioned values and any point value within that range).

In some embodiments, the addition amount of the second additive ranges from 1 wt % to 5 wt % of a total mass of the electrolyte solution (for example, 1 wt %, 2 wt %, 3 wt %, 4 wt %, 5 wt %, or any range composed of any two of the aforementioned values and any point value within that range).

In some embodiments, the addition amount of the third additive ranges from 0.1 wt % to 1 wt % of a total mass of the electrolyte solution (for example, 0.1 wt %, 0.2 wt %, 0.3 wt %, 0.4 wt %, 0.5 wt %, 0.6 wt %, 0.7 wt %, 0.8 wt %, 0.9 wt %, 1 wt %, or any range composed of any two of the aforementioned values and any point value within that range).

In specific embodiments provided by the present application, the addition amount of the third additive ranges from 0.13 wt % to 1 wt % of the total mass of the electrolyte solution.

Preferably, when the contents of the first additive, the second additive, and the third additive are within the above-mentioned ranges, the synergistic effect of the three additives can be better, which is more conducive to improving the cell and safety performance, while also taking into account the long-cycle and low-expansion performance.

In some embodiments, the addition amounts of the first additive and the second additive satisfy:

$$0.07 ⩽ {C}_{A} / {C}_{B} \leq 0.8 ,$$

where C_{A} represents the addition amount of the first additive, and C_{B} represents the addition amount of the second additive. The ratio of C_{A}/C_{B} can be 0.07, 0.1, 0.2, 0.3, 0.4, 0.5, 0.6, 0.7, 0.8, or any range composed of any two of the aforementioned values and any point value within that range. Preferably, when the ratio of the addition amounts of the first additive and the second additive is within the above-mentioned range, it can avoid the situation where an overly small C_{A}/C_{B} ratio leads to an overly thick film on the negative electrode side, resulting in excessive impedance and deteriorating the battery's cycle charging window. Moreover, it can prevent the issue that an overly large C_{A}/C_{B} ratio leads to uneven film formation on the negative electrode side, which cannot effectively reduce the cycling expansion.

In some preferred embodiments, the addition amounts of the first additive and the second additive satisfy:

0.08≤C_{A}/C_{B}≤0.77. Further optimizing the ratio of the addition amounts of the first additive and the second additive can better promote the synergistic effect of the two additives. It is more conducive to the formation of a stable SEI film on the negative electrode surface, more effectively prevents the electrolyte solution from being reduced on the negative electrode surface, reduces the heat release from side reactions, and mitigates the problem of increased cycling expansion caused by the silicon-based negative electrode, thereby enhancing the safety performance and long cycle life of the battery.

In some embodiments, the organic solvent includes a first organic solvent, or the organic solvent includes a first organic solvent and a second organic solvent. The first organic solvent includes ethyl propionate. The second organic solvent includes at least one selected from ethylene carbonate (EC), propylene carbonate (PC), dimethyl carbonate, diethyl carbonate, ethyl methyl carbonate, propyl propionate (PP), or propyl acetate.

In specific embodiments provided by the present application, the second organic solvent includes ethylene carbonate (EC), propylene carbonate (PC), and propyl propionate (PP). These three solvents can be mixed in any mass ratio, and an exemplary ratio is 1:1:1.

In some embodiments, the addition amount of the first organic solvent ranges from 5 wt % to 70 wt % of the total mass of the electrolyte solution. For example, 5 wt %, 10 wt %, 20 wt %, 30 wt %, 40 wt %, 50 wt %, 60 wt %, 70 wt %, or any range composed of any two of the aforementioned values and any point value within that range.

In some embodiments, the addition amount of the first organic solvent ranges from 20 wt % to 60 wt % of the total mass of the electrolyte solution. For example, 20 wt %, 30 wt %, 40 wt %, 50 wt %, 60 wt %, or any range composed of any two of the aforementioned values and any point value within that range.

In some embodiments, the addition amount of the first organic solvent ranges from 20 wt % to 50 wt % of the total mass of the electrolyte solution.

In some embodiments, the lithium salt includes lithium hexafluorophosphate and/or lithium bis(trifluoromethanesulphonyl)imide. In the electrolyte solution, the synergistic combination of lithium hexafluorophosphate and/or lithium bis(trifluoromethanesulphonyl)imide with the ethyl propionate solvent can significantly improve the battery safety performance, enabling simultaneous optimization of thermal shock performance, overcharge performance, and nail penetration performance of the battery.

In some embodiments, the addition amount of lithium hexafluorophosphate ranges from 13 wt % to 20 wt % of the total mass of the electrolyte solution. For example, 13 wt %, 14 wt %, 15 wt %, 16 wt %, 17 wt %, 18 wt %, 19 wt %, 20 wt %, or any range composed of any two of the aforementioned values and any point value within that range.

In some embodiments, the addition amount of lithium bis(trifluoromethanesulphonyl)imide ranges from 0.5 wt % to 10 wt % of the total mass of the electrolyte solution, For example, 0.5 wt %, 1 wt %, 2 wt %, 3 wt %, 4 wt %, 5 wt %, 6 wt %, 7 wt %, 8 wt %, 9 wt %, 10 wt %, or any range composed of any two of the aforementioned values and any point value within that range.

When the content ratios of lithium hexafluorophosphate and lithium bis(trifluoromethanesulphonyl)imide are within the above-mentioned ranges, the interfacial compatibility between the electrode and the electrolyte solution can be further improved, and the side reactions between the electrode active material and the electrolyte solution can be more effectively inhibited.

In some embodiments, the electrolyte solution further includes a fourth additive and/or a fifth additive.

In some embodiments, the fourth additive includes at least one selected from tris(trimethylsilyl) phosphite, tris(trimethylsilyl) borate, lithium bis(fluorosulfonyl)imide, 1,3-propane sultone, 1,3-propene sultone, ethylene sulphite, ethylene sulfate, vinylene carbonate, fluoroethylene carbonate, lithium bis(oxalate)borate, lithium difluoro oxalate phosphate, or vinyl ethylene carbonate. Further introducing the fourth additive enables the formation of a more flexible composite protective film on the negative electrode plate, thereby enhancing the safety performance of the battery cell.

In some embodiments, the addition amount of the fourth additive ranges from 0 to 10 wt % of the total mass of the electrolyte solution. For example, 0.1 wt %, 0.5 wt %, 1 wt %, 2 wt %, 3 wt %, 4 wt %, 5 wt %, 6 wt %, 7 wt %, 8 wt %, 9 wt %, 10 wt %, or any range composed of any two of the aforementioned values and any point value within that range.

In some embodiments, the fifth additive includes a fluorine-substituted borate ether compound. Further introducing the fifth additive, fluorine-substituted borate ether compound, enables the formation of a more flexible composite protective film on the negative electrode plate, thereby enhancing the safety performance of the battery cell.

In some embodiments, the fluorine-substituted borate ether compound includes at least one compound selected from Formula T9 to Formula T11;

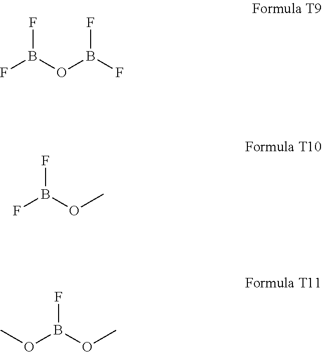

In some embodiments, the addition amount of the fluorine-substituted borate ether compound ranges from 0.1 wt % to 1 wt % of the total mass of the electrolyte solution. For example, 0.1 wt %, 0.5 wt %, 1 wt %, 2 wt %, 3 wt %, 4 wt %, 5 wt %, 6 wt %, 7 wt %, 8 wt %, 9 wt %, 10 wt %, or any range composed of any two of the aforementioned values and any point value within that range. When the addition amount of the fluorine-substituted borate ether compound is within the above-mentioned range, it can avoid the situation where the film-forming effect is not obvious due to an insufficient content, and also avoid the situation where the film is too thick due to an excessive content, which will increase the impedance and deteriorating the cycling/charging window.

The present application also provides a lithium-ion battery, where the battery includes a positive electrode plate, a negative electrode plate, a separator disposed between the positive electrode plate and the negative electrode plates, and the above-mentioned electrolyte solution.

In the present application, the negative electrode active material of the negative electrode plate includes a silicon-based material.

In some embodiments, the silicon-based material is selected from at least one of silicon, silicon carbide, SiOₓ or SiO₂, where 0<x<2.

In some embodiments, the negative electrode active material of the negative electrode plate further includes a carbon material.

Preferably, the carbon material includes at least one of artificial graphite, natural graphite, mesocarbon microbead, hard carbon, or soft carbon.

In specific embodiments provided by the present application, the carbon material includes graphite material.

In some embodiments, the mass ratio of the silicon-based material to the carbon material is (1-4):(60-99).

Preferably, the mass ratio of the silicon-based material to the carbon material is (5-30):(70-95).

In specific embodiments provided by the present application, the negative active material of the negative electrode plate includes a mixture of graphite and silicon carbide, or a mixture of graphite and SiO₂.

In specific embodiments provided by the present application, the negative electrode plate includes a negative electrode current collector and a negative electrode active material layer coated on at least one side surface of the negative electrode current collector. The negative electrode active material layer includes a negative electrode active material, a conductive agent, and a binder.

Preferably, the mass percentages of the components in the negative electrode active material layer are: 70 wt %-99.7 wt % of the negative electrode active material, 0.1 wt %-10 wt % of the conductive agent, and 0.1 wt %-10 wt % of the binder.

In an exemplary embodiment provided by the present application, the mixing mass ratio of the negative electrode active material, the conductive agent, and the binder is 97.4:0.7:1.9.

Preferably, the positive electrode plate includes a positive electrode current collector and a positive electrode active material layer coated on at least one side surface of the positive electrode current collector. The positive active material layer includes a positive electrode active material, a conductive agent, and a binder.

Preferably, the mass percentages of the components in the positive electrode active material layer are: 70 wt %-99.7 wt % of the positive electrode active material, 0.1 wt %-10 wt % of the conductive agent, and 0.1 wt %-10 wt % of the binder.

In an exemplary embodiment provided by the present application, the mixing mass ratio of the positive active material, the conductive agent, and the binder is 97.6:1.1:1.3.

In some embodiments, the positive electrode active material includes lithium cobalt oxide (LiCoO₂) or lithium cobalt oxide doped or coated with two, three, or more elements selected from Al, Mg, Mn, Cr, Ti, and Zr. The chemical formula of the doped or coated lithium cobalt oxide is LiₓCo_{1-y1-y2-y3-y4}A_{y1}B_{y2}C_{y3}D_{y4}O₂, where: 0.95≤x≤1.05, 0.01≤y1≤0.1, 0.01≤y2≤0.1, 0≤y3≤0.1, 0≤y4≤0.1, A, B, C, D are independently selected from two or more elements among Al, Mg, Mn, Cr, Ti, Zr.

Preferably, the doped or coated lithium cobalt oxide has a Dv50 ranging from 10 μm to 17 μm and a specific surface area (BET) ranging from 0.15 m²/g to 0.45 m²/g.

In some embodiments, the conductive agent includes at least one of conductive carbon black, acetylene black, Keqin black, conductive graphite, conductive carbon fiber, carbon nanotube, metal powder, or carbon fiber.

In some embodiments, the binder includes at least one of polyvinylidene fluoride (PVDF), styrene-butadiene rubber (SBR), sodium carboxymethyl cellulose (CMC), polytetrafluoroethylene (PTFE), polyethylene oxide.

In specific embodiments provided by the present application, the conductive agent in the positive electrode active material layer includes acetylene black.

In specific embodiments provided by the present application, the binder in the positive electrode active material layer includes PVDF.

In specific embodiments provided by the present application, the conductive agent in the negative electrode active material layer includes conductive carbon black and carbon nanotube.

In specific examples provided by the present application, the binder in the negative electrode active material layer includes SBR and CMC.

In some embodiments, the lithium-ion battery is a high voltage lithium-ion battery.

In some embodiments, the charging cut-off voltage of the lithium-ion battery is 4.5V or higher.

Compared with the conventional technology, the present application has the following advantageous effects.

(1) The electrolyte solution of the present application effectively enhances cell and safety performance while balancing long cycle life and low expansion performance through synergistic interactions between additives. Specifically, the combination of the first additive (silane compound) and the second additive (polycyclic compound) cross-links forming a thicker and more stable SEI protective film on the negative electrode surface at optimized addition ratios. This film prevents electrolyte solution from being reduced on the negative electrode surface, thereby reducing heat release from side reactions and mitigating cycling expansion issues caused by silicon-based negative electrodes, thus enhancing battery safety and long cycle life. Furthermore, the introduction of the third additive (lithium difluoro(oxalato)borate) enables the combination of the three types of additives forming a more flexible composite protective film on the negative electrode plate, further enhancing the safety performance of the cell.

(2) The further introduction of the fifth additive (fluorine-substituted borate ether compound) enables the combination of four types of additives forming a composite protective film with enhanced toughness on the negative electrode plate, enhancing the safety performance of the cell.

(3) The non-aqueous electrolyte solution of the present application further incorporates an appropriate amount of ethyl propionate and lithium bis(trifluoromethanesulphonyl)imide (LiTFSI), thereby reducing solvent viscosity, enhancing lithium-ion transference, significantly improving electrolyte solution wettability and ionic conductivity. These modifications mitigate the low-temperature disadvantages caused by the relatively thick SEI film with higher impedance formed by the combined use of silane compound and polycyclic compound, thereby enhancing the low-temperature performance of the cell.

(4) Through the synergistic effect between the electrolyte solution and the negative electrode material, the lithium-ion battery with a silicon-based negative electrode prepared by the present application can effectively improve cell safety performance while maintaining long cycle life and low-temperature performance.

The present application discloses an electrolyte solution and a lithium-ion battery, which can be implemented by those skilled in the art by referring to the content herein and adjusting process parameters appropriately. It should be particularly noted that: All similar substitutions and modifications that are obvious to those skilled in the art are considered to be included in the present application. The methods and applications of the present application have been described through exemplary embodiments, and relevant personnel can clearly make alterations, appropriate modifications, or combinations to the methods and applications herein without departing from the content, spirit, and scope of the present application to implement and apply the technology.

Reagents and materials used in the present application are commercially available. CAS numbers for Formula T9-T11 are as follows.

| Compound | CAS Number |
|---|---|
| Formula T9 | CAS: 12523-60-3 |
| Formula T10 | CAS: 381-59-9 |
| Formula T11 | CAS: 367-46-4 |

Examples are provided below to further illustrate the present application:

### Comparative Examples 1-7 and Examples 1-10

The lithium-ion batteries of Comparative Examples 1-7 and Examples 1-10 were prepared according to the following methods, with differences only in the selection of negative electrode plates and electrolyte solutions as shown in Table 1.

### (1) Preparation of a Positive Electrode Plate

Positive active material LiCoO₂, binder polyvinylidene fluoride (PVDF), and conductive agent acetylene black were mixed at a mass ratio of 97.6:1.1:1.3. N-methylpyrrolidone (NMP) was added, and the mixture was stirred under vacuum in a mixer until a mixed system became a positive electrode slurry with uniform fluidity. The positive electrode slurry was evenly applied on an aluminum foil having a thickness of 11 μm. The coated foil was baked in a five-stage oven with different temperatures and then dried in an oven at 120° C. for 8 hours, followed by roll-pressing and cutting, to obtain the positive electrode plate.

### (2) Preparation of a Negative Electrode Plate

Different negative active materials (specific compositions and types shown in Table 1), a conductive agent single-walled carbon nanotubes (SWCNT), a conductive agent conductive carbon black (SP), a binder sodium carboxymethyl cellulose (CMC), and a binder styrene-butadiene rubber (SBR) were mixed at a mass ratio of 97.4:0.1:0.6:0.9:1.0. The mixture was formed into a negative electrode slurry via a wet process. The negative electrode slurry was evenly applied on a copper foil (negative electrode current collector) having a thickness of 6 μm. The coated foil was dried at 85° C. for 5 hours, roll-pressed, and die-cut to obtain the negative electrode plate.

### (3) Preparation of a Non-Aqueous Electrolyte Solution

In an argon-filled glovebox (moisture <10 ppm, oxygen <1 ppm), ethylene carbonate (EC), propylene carbonate (PC), and propyl propionate (PP) were evenly mixed at a mass ratio of 1:1:1. Then, lithium hexafluorophosphate (LiPF₆) accounting for 14 wt % of a total mass of the non-aqueous electrolyte solution, ethyl propionate accounting for 5 wt %-70 wt % of the total mass of the non-aqueous electrolyte solution (specific percentages as shown in Table 1), and additives (specific types and percentages as shown in Table 1) were slowly added into the mixed solution. The mixture was stirred evenly to obtain the non-aqueous electrolyte solution.

### (4) Preparation of a Separator

A 5 μm-thick polyethylene-based film coated on both sides with a 2 μm-thick composite layer containing titanium oxide and polyvinylidene fluoride-hexafluoropropylene copolymer (PVDF-HFP).

### (5) Preparation of a Lithium-Ion Battery

The prepared positive electrode plate, separator, and negative electrode plate were wound to form unfilled bare cell. The bare cell was placed in an aluminum-plastic film, and the prepared non-aqueous electrolyte solution was injected into the dried bare cell. After processes such as vacuum packaging, standing, formation, shaping, and sorting, the lithium-ion battery required was obtained.

TABLE 1
Lithium-ion batteries obtained in the Comparative Examples 1-7 and Examples 1-10

| | | | | | lithium | | fluorine- | negative |
|---|---|---|---|---|---|---|---|---|
| | | | | lithium | bis(trifluoro- | | substituted | electrode |
| Comparative | | polycyclic | | difluoro- | methane- | ethyl | borate ether | active |
| example/ | Tetravinylsilane | compound | | (oxalato)- | sulphonyl) | propionate/ | compound/ | material/ |
| Example | C_{A}/wt % | C_{B}/wt % | C_{A}/C_{B} | borate/wt % | imide/wt % | wt % | wt % | wt % |
| Comparative | 0.5 wt % | / | / | / | / | / | / | graphite |
| example 1 | | | | | | | | (85 wt %) + |
| | | | | | | | | SiC |
| | | | | | | | | (15 wt %) |
| Comparative | / | 2.0 wt % | / | / | / | / | / | graphite |
| example 2 | | Formula T2 | | | | | | (85 wt %) + |
| | | | | | | | | SiC |
| | | | | | | | | (15 wt %) |
| Comparative | 0.5 wt % | 2.0 wt % | 0.25 | / | / | / | / | graphite |
| example 3 | | Formula T2 | | | | | | (85 wt %) + |
| | | | | | | | | SiC |
| | | | | | | | | (15 wt %) |
| Comparative | 0.5 wt % | 2.0 wt % | 0.25 | 0.5 wt % | / | / | / | graphite |
| example 4 | | Formula T2 | | | | | | (85 wt %) + |
| | | | | | | | | SiC |
| | | | | | | | | (15 wt %) |
| Comparative | 0.5 wt % | 2.0% wt | 0.25 | 0.5 wt % | 3.0 wt % | / | / | graphite |
| example 5 | | Formula T2 | | | | | | (85 wt %) + |
| | | | | | | | | SiC |
| | | | | | | | | (15 wt %) |
| Comparative | / | 2.0 wt % | / | 0.5 wt % | 3.0 wt % | 30.0 wt % | / | graphite |
| example 6 | | Formula T2 | | | | | | (85 wt %) + |
| | | | | | | | | SiC |
| | | | | | | | | (15 wt %) |
| Comparative | 0.9 wt % | 1.0 wt % | 0.9 | 0.5 wt % | 3.0 wt % | 30.0 wt % | / | graphite |
| example 7 | | Formula T2 | | | | | | (85 wt %) + |
| | | | | | | | | SiC |
| | | | | | | | | (15 wt %) |
| Example 1 | 0.5 wt % | 2.0 wt % | 0.25 | 0.5 wt % | 3.0 wt % | 30.0 wt % | / | graphite |
| | | Formula T2 | | | | | | (85 wt %) + |
| | | | | | | | | SiC |
| | | | | | | | | (15 wt %) |
| Example 2 | 0.9 wt % | 3.0 wt % | 0.30 | 0.2 wt % | 5.0 wt % | 40.0 wt % | / | graphite |
| | | Formula T5 | | | | | | (85 wt %) + |
| | | | | | | | | SiC |
| | | | | | | | | (15 wt %) |
| Example 3 | 0.4 wt % | 2.5 wt % | 0.16 | 0.3 wt % | 6.0 wt % | 25.0 wt % | / | graphite |
| | | Formula T3 | | | | | | (85 wt %) + |
| | | | | | | | | SiC |
| | | | | | | | | (15 wt %) |
| Example 4 | 0.6 wt % | 1.5 wt % | 0.40 | 0.25 wt % | 4.0 wt % | 35.0 wt % | / | graphite |
| | | Formula T1 | | | | | | (85 wt %) + |
| | | | | | | | | SiC |
| | | | | | | | | (15 wt %) |
| Example 5 | 0.3 wt % | 1.0 wt % | 0.30 | 0.35 wt % | 2.0 wt % | 20.0 wt % | / | graphite |
| | | Formula T4 | | | | | | (90 wt %) + |
| | | | | | | | | SiC |
| | | | | | | | | (10 wt %) |
| Example 6 | 0.8 wt % | 4.0 wt % | 0.20 | 0.6 wt % | 8.0 wt % | 60.0 wt % | / | graphite |
| | | Formula T7 | | | | | | (70 wt %) + |
| | | | | | | | | SiC |
| | | | | | | | | (30 wt %) |
| Example 7 | 0.5 wt % | 2.0 wt % | 0.25 | 0.5% | 3.0 wt % | 30.0 wt % | 0.1 wt % | graphite |
| | | Formula T2 | | | | | Formula T10 | (85 wt %) + |
| | | | | | | | | SiC |
| | | | | | | | | (15 wt %) |
| Example 8 | 0.4 wt % | 5.0 wt % | 0.08 | 1.0 wt % | 10.0 wt % | 70.0 wt % | 1 wt % | graphite |
| | | Formula T6 | | | | | Formula T9 | (70 wt %) + |
| | | | | | | | | SiC |
| | | | | | | | | (30 wt %) |
| Example 9 | 1.0 wt % | 1.3 wt % | 0.77 | 0.1 wt % | 1.0 wt % | 5.0 wt % | 0.5 wt % | graphite |
| | | Formula T8 | | | | | Formula T11 | (95 wt %) + |
| | | | | | | | | SiO₂ |
| | | | | | | | | (5 wt %) |
| Example 10 | 0.2 wt % | 1.6 wt % | 0.13 | 0.15 wt % | 0.5 wt % | 15.0 wt % | 0.2 wt % | graphite |
| | | Formula T2 | | | | | Formula T9 | (95 wt %) + |
| | | | | | | | | SiC |
| | | | | | | | | (5 wt %) |

Note:
“/” indicates no addition.

### Example Group 11

The procedure was performed with reference to Example 7, with differences in the addition amounts of tetravinylsilane and the polycyclic compound to adjust the C_{A}/C_{B} ratio:

Example 11a: The addition amount C_{A} of tetravinylsilane is 0.21 wt %, the addition amount C_{B} of polycyclic compound is 3 wt %, and C_{A}/C_{B}=0.07.

Example 11b: The addition amount C_{A} of tetravinylsilane) is 0.96 wt %, the addition amount C_{B} of polycyclic compound is 1.2 wt %, and C_{A}/C_{B}=0.8.

Example 11c: The addition amount C_{A} of tetravinylsilane is 0.2 wt %, the addition amount C_{B} of polycyclic compound) is 4 wt %, and C_{A}/C_{B}=0.05.

### Example Group 12

The procedure was performed with reference to Example 7, with differences in the addition amount of the ethyl propionate in the electrolyte solution.

Example 12a: Ethyl propionate was added at 60 wt % based on the total mass of the electrolyte solution.

Example 12b: Ethyl propionate was added at 5 wt % based on the total mass of the electrolyte solution.

Example 12c: Ethyl propionate was added at 75 wt % based on the total mass of the electrolyte solution.

Example 12d: Ethyl propionate was added at 3 wt % based on the total mass of the electrolyte solution.

### Example Group 13

The procedure was performed with reference to Example 7, with differences in the addition amounts of the following components in the electrolyte solution.

Example 13a: Tetravinylsilane was added at 1.2 wt % based on the total mass of the electrolyte solution.

Example 13b: The polycyclic compound was added at 6 wt % based on the total mass of the electrolyte solution.

Example 13c: Lithium difluoro(oxalato)borate was added at 2 wt % based on the total mass of the electrolyte solution.

Example 13d: lithium bis(trifluoromethanesulphonyl)imide was added at 0.3 wt % based on the total mass of the electrolyte solution.

Example 13e: Fluorine-substituted borate ether compound was added at 2 wt % based on the total mass of the electrolyte solution.

### Electrochemical Performance Test of the Batteries

The batteries obtained in the above Comparative Examples 1-7 and Examples 1-10 were tested for electrochemical performance. The related description are as follows.

### (1) 25° C. Cycle Test

The batteries obtained in the Examples and Comparative Examples were placed in an environment of (25±2°) C to stand for 2-3 hours. When the battery bodies reached (25±2°) C, the batteries were charged at constant current of 1.5C, with a cut-off current of 0.05 C. After the batteries were fully charged, the batteries were left aside for 5 minutes, and then discharged at a constant current of 0.7 C to a cut-off voltage of 3.0 V. A highest discharge capacity in the first 3 cycles was recorded as an initial capacity Q. After completing 800 cycles, the last discharge capacity Q₁ of the battery was recorded. An initial thickness T and a thickness T₁ after 300 cycles were recorded.

$$Capacity retention rate ( \% ) = {Q}_{1} / Q \times 100 \% .$$

$$Thickness change rate ( \% ) = ( {T}_{1} - T ) / T \times 100 \% .$$

### (2) Low-Temperature Discharge Test

The batteries obtained in the Examples and Comparative Examples were first discharged at 0.2 C to 3.0 V at an ambient temperature of (25±3°) C, and left aside for 5 minutes. The batteries were charged at 0.7 C, and when a voltage across cell terminals reached a charging limit voltage, the batteries began to be charged at a constant voltage. The charging was not stopped until a charging current is less than or equal to a cut-off current. The batteries were left aside for five minutes and then discharged at 0.2 C to 3.0 V, and a discharge capacity in this case was recorded as a normal-temperature capacity Q₂. Then, the cells were charged at 0.7 C, and when a voltage across the cell terminals reached a charging limit voltage, the batteries began to be charged at a constant voltage. The charging was not stopped until a charging current is less than or equal to a cut-off current. The fully charged batteries were left aside at (−10±2°) C for 4 hours, and then discharged at a current of 0.4 C to a cut-off voltage of 3.0 V. A discharge capacity Q₃ was recorded to calculate a low-temperature discharge capacity retention rate. Recorded results are shown in Table 2.

$$Low - temperature discharge capacity retention rate ( \% ) = {Q}_{3} / {Q}_{2} \times 100 \% .$$

### (3) 140° C. Thermal Shock Test

The batteries obtained in the Examples and Comparative Examples were heated in a convection mode or by using a circulation hot air chamber a circulation hot air chamber (25±3°) C, with a temperature change rate of (5±2°) C/min. The temperature was raised to (140±2°) C, and the batteries were kept in the temperature for 60 minutes. The batteries state was recorded (results in Table 2).

### (4) Overcharge Test

The batteries obtained in the Examples and Comparative Examples were charged at a constant current of 3C to 5V. The battery state was recorded (results in Table 2).

### (5) Nail Penetration Test

A high-temperature resistant steel needle (a cone angle of the needle tip ranges from 45° to 60°, and a surface of the needle is smooth without rust, oxide layer, or grease) with a diameter of φ ranging from 5 mm to 8 mm penetrated through the batteries obtained in Examples and Comparative Examples from a direction perpendicular to electrode plates of the batteries at a speed of (25±5) mm/s. The puncture position was preferably close to a geometric center of a pierced surface, with the needle remained in the batteries. Based on observation, after one hour or when a maximum temperature of surfaces of the batteries dropped to 10° C. or below, the test ended.

TABLE 2
Experimental test results of the batteries obtained in the Comparative
Examples 1-7, Examples 1-10, and Example Groups 11-13

| | | | | Safety Tests: “Pass Criteria: No Fire/Explosion” | | |
|---|---|---|---|---|---|---|
| | | | | 140° C. | Overcharge | |
| | | | | Thermal | Test at | Nail |
| | 25° C. 1.5 C Cycle Life | | Discharge | Shock (60 | 3 C-5 V | Penetration |
| | (800 Cycles) | | Capacity | min) (number | (number of | (number of |
| Comparative | Capacity | Thickness | Retention | of passed/ | passed/ | passed/ |
| example/ | Retention | Change | rate at −10° C. | number of | number of | number of |
| Example | Rate | Rate | and 0.4 C | tested) | tested) | tested) |
| Comparative | 59.23% | 29.2% | 57.42% | 1/5 | 0/5 | 0/5 |
| example 1 | | | | | | |
| Comparative | 60.14% | 27.3% | 55.31% | 0/5 | 1/5 | 0/5 |
| example 2 | | | | | | |
| Comparative | 62.64% | 24.4% | 54.35% | 2/5 | 1/5 | 1/5 |
| example 3 | | | | | | |
| Comparative | 66.56% | 22.7% | 55.33% | 1/5 | 2/5 | 1/5 |
| example 4 | | | | | | |
| Comparative | 72.28% | 20.1% | 60.31% | 3/5 | 4/5 | 4/5 |
| example 5 | | | | | | |
| Comparative | 65.46% | 21.1% | 66.51% | 1/5 | 2/5 | 1/5 |
| example 6 | | | | | | |
| Comparative | 78.95% | 15.3% | 68.42% | 4/5 | 3/5 | 3/5 |
| example 7 | | | | | | |
| Example 1 | 82.37% | 12.4% | 71.14% | 5/5 | 5/5 | 5/5 |
| Example 2 | 83.46% | 11.4% | 75.14% | 5/5 | 5/5 | 5/5 |
| Example 3 | 81.22% | 13.5% | 73.08% | 5/5 | 5/5 | 5/5 |
| Example 4 | 84.28% | 11.9% | 76.14% | 5/5 | 5/5 | 5/5 |
| Example 5 | 82.14% | 12.6% | 70.45% | 5/5 | 5/5 | 5/5 |
| Example 6 | 79.11% | 11.6% | 78.50% | 5/5 | 5/5 | 5/5 |
| Example 7 | 86.33% | 10.3% | 72.51% | 5/5 | 5/5 | 5/5 |
| Example 8 | 84.73% | 11.3% | 81.31% | 5/5 | 5/5 | 5/5 |
| Example 9 | 87.41% | 9.6% | 70.52% | 5/5 | 5/5 | 5/5 |
| Example 10 | 88.43% | 9.5% | 71.15% | 5/5 | 5/5 | 5/5 |
| Example 11a | 82.33% | 12.4% | 71.3% | 5/5 | 5/5 | 5/5 |
| Example 11b | 81.04% | 13.8% | 70.2% | 5/5 | 5/5 | 5/5 |
| Example 11c | 79.2% | 14.6% | 69.3% | 4/5 | 4/5 | 4/5 |
| Example 12a | 84.61% | 11.3% | 71.6% | 5/5 | 5/5 | 5/5 |
| Example 12b | 85.22% | 12.1% | 70.8% | 5/5 | 5/5 | 5/5 |
| Example 12c | 81.26% | 13.4% | 69.9% | 4/5 | 5/5 | 4/5 |
| Example 12d | 80.41% | 14.7% | 69.1% | 4/5 | 4/5 | 5/5 |
| Example 13a | 82.29% | 11.1% | 71.2% | 5/5 | 5/5 | 5/5 |
| Example 13b | 83.61% | 10.9% | 71.9% | 5/5 | 5/5 | 5/5 |
| Example 13c | 80.29% | 12.3% | 70.8% | 5/5 | 5/5 | 5/5 |
| Example 13d | 79.42% | 14.9% | 69.9% | 5/5 | 5/5 | 5/5 |
| Example 13e | 80.40% | 13.8% | 70.1% | 5/5 | 5/5 | 5/5 |

It can be learned from the experimental test results in Table 2 that, comparative analysis of comparative Example 1, Comparative Example 2, Comparative Example 6, and Example 1 clearly demonstrates that the individual use of tetravinylsilane (first additive) or polycyclic compound (second additive) produces inadequate performance, failing to meet requirements for both cycling performance and safety performance.

Comparative analysis of Comparative Examples 1, 2, and 3 demonstrates that, the simultaneous incorporation of both tetravinylsilane and polycyclic compound in Comparative Example 3 significantly improved the battery's cycling performance and safety performance.

Comparative analysis of Comparative Examples 3, 4, and 5 reveals that, when lithium difluoro(oxalato)borate was added as the third additive to Comparative Example 3's formulation to produce Comparative Example 4, and when lithium bis(trifluoromethanesulphonyl)imide was subsequently added into Comparative Example 4 to produce Comparative Example 5. As a result, the cycling performance and safety performance of Comparative Example 5 were further improved.

Comparative analysis of Comparative Example 7 and Example 1 further demonstrates that, when the C_{A}/C_{B} ratio exceeded the ranges defined in the present application, it directly affected both the cycling performance and safety performance of the battery.

Comparative analysis of Example 1 and Example 7 demonstrates that, when fluorine-substituted borate ether compound was added as the fifth additive to Example 1's formulation to produce Example 7, the battery in Example 7 demonstrated significantly improved cycling performance.

Comparative analysis of Examples 1-6 reveals that, when different additive types and contents, various lithium salt concentrations, and different ethyl propionate contents were substituted, the batteries in Examples 1-6 exhibited excellent results in both cycling performance and safety performance.

Comparative analysis of Examples 7-10 reveals that, when different additive types and contents, various lithium salt concentrations, different ethyl propionate contents, and different fluorine-substituted borate ether compound types and contents were substituted, the batteries in Examples 7-10 showed excellent cycling performance and safety performance.

In summary, when the electrolyte solution contains the complete combination of ethyl propionate, lithium difluoro(oxalato)borate, silane compound, polycyclic compound, lithium bis(trifluoromethanesulphonyl)imide, and fluorine-substituted borate ether compound, with the C_{A}/C_{B} ratio maintained within an appropriate range, the synergistic interactions between the additives and solvents produced significant improvements. Specifically, the combined use of tetravinylsilane and polycyclic compound can form a thicker and more stable SEI protective film on the negative electrode surface through cross-linking when added in a specific proportion. This film prevents the electrolyte solution from being reduced on the negative electrode surface, thereby mitigating the problem of increased cycling expansion caused by silicon-based negative electrode plate, thus enhancing safety performance and long cycle life of the battery. Furthermore, the introduction of fluorine-substituted borate ether compound and lithium difluoro(oxalato)borate enables the four types of additives forming a more flexible composite protective film on the negative electrode, further enhancing the safety performance of the cell.

The above descriptions merely represent preferred embodiments of the present application. It should be noted that those skilled in the art may make modifications and improvements without departing from the principles of the present application, and such modifications and improvements shall also be deemed within the protection scope of the present application.

1. An electrolyte solution, comprising an organic solvent, a lithium salt, a first additive, a second additive, and a third additive; wherein
the first additive comprises a silane compound;
the second additive comprises a polycyclic compound; and
the third additive comprises lithium difluoro(oxalato)borate.

2. The electrolyte solution according to claim 1, wherein the silane compound of the first additive comprises tetravinylsilane.

3. The electrolyte solution according to claim 1, wherein the polycyclic compound of the second additive comprises at least one compound selected from Formula T1 to Formula T8:

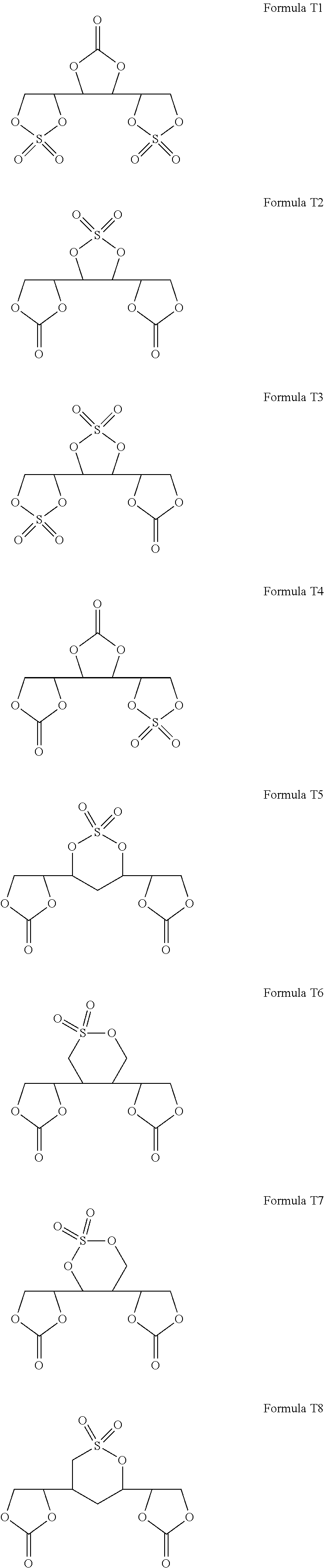

4. The electrolyte solution according to claim 1, wherein:
the addition amount of the first additive ranges from 0.2 wt % to 1 wt % of a total mass of the electrolyte solution;
and/or the addition amount of the second additive ranges from 1 wt % to 5 wt % of a total mass of the electrolyte solution;
and/or the addition amount of the third additive ranges from 0.1 wt % to 1 wt % of a total mass of the electrolyte solution.

5. The electrolyte solution according to claim 1, wherein the addition amounts of the first additive and the second additive satisfy:
0.07≤C_{A}/C_{B}≤0.8,
wherein C_{A} represents the addition amount of the first additive and C_{B} represents the addition amount of the second additive.

6. The electrolyte solution according to claim 1, wherein:
the organic solvent comprises a first organic solvent, or the organic solvent comprises a first organic solvent and a second organic solvent;
the first organic solvent comprises ethyl propionate;
and/or the second organic solvent comprises at least one selected from ethylene carbonate, propylene carbonate, dimethyl carbonate, diethyl carbonate, ethyl methyl carbonate, propyl propionate, or propyl acetate.

7. The electrolyte solution according to claim 6, wherein the addition amount of the first organic solvent ranges from 5 wt % to 70 wt % of the total mass of the electrolyte solution.

8. The electrolyte solution according to claim 1, wherein the lithium salt comprises lithium hexafluorophosphate and/or lithium bis(trifluoromethanesulphonyl)imide.

9. The electrolyte solution according to claim 8, wherein:
the addition amount of lithium hexafluorophosphate ranges from 13 wt % to 20 wt % of the total mass of the electrolyte solution;
the addition amount of lithium bis(trifluoromethanesulphonyl)imide ranges from 0.5 wt % to 10 wt % of the total mass of the electrolyte solution.

10. The electrolyte solution according to claim 1, wherein the electrolyte solution further comprises a fourth additive and/or a fifth additive:
the fourth additive comprises at least one selected from tris(trimethylsilyl) phosphite, tris(trimethylsilyl) borate, lithium bis(fluorosulfonyl)imide, 1,3-propane sultone, 1,3-propene sultone, ethylene sulphite, ethylene sulfate, vinylene carbonate, fluoroethylene carbonate, lithium bis(oxalate)borate, lithium difluoro oxalate phosphate, or vinyl ethylene carbonate;
and/or the fifth additive comprises a fluorine-substituted borate ether compound,
the fluorine-substituted borate ether compound comprises at least one compound selected from Formula T9 to Formula T11:

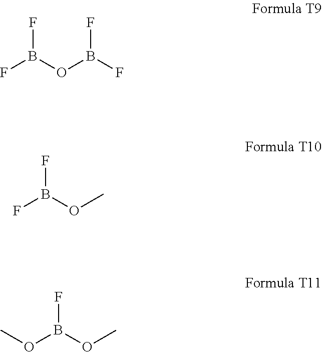

11. The electrolyte solution according to claim 10, wherein:
the addition amount of the fourth additive ranges from 0 to 10 wt % of the total mass of the electrolyte solution;
and/or the addition amount of the fluorine-substituted borate ether compound ranges from 0.1 wt % to 1 wt % of the total mass of the electrolyte solution.

12. A lithium-ion battery, wherein the battery comprises a positive electrode plate, a negative electrode plate, a separator disposed between the positive electrode plate and the negative electrode plate, and the electrolyte solution according to claim 1;
a negative electrode active material of the negative electrode plate comprises a silicon-based material.

13. The lithium-ion battery according to claim 12, wherein the silicon-based material is selected from at least one of silicon, silicon carbide, SiOₓ or SiO₂, and 0<x<2.

14. The lithium-ion battery according to claim 12, wherein the negative electrode active material of the negative electrode plate further comprises a carbon material;
the carbon material is selected from at least one of artificial graphite, natural graphite, mesocarbon microbead, hard carbon, or soft carbon.

15. The lithium-ion battery according to claim 14, wherein a mass ratio of the silicon-based material to the carbon material is (1-40):(60-99).

16. The electrolyte solution according to claim 5, wherein the addition amounts of the first additive and the second additive satisfy: 0.08≤C_{A}/C_{B}≤0.77.

17. The electrolyte solution according to claim 6, wherein the second organic solvent comprises ethylene carbonate, propylene carbonate, and propyl propionate.

18. The electrolyte solution according to claim 7, wherein the addition amount of the first organic solvent ranges from 20 wt % to 60 wt % of the total mass of the electrolyte solution.

19. The lithium-ion battery according to claim 14, wherein the negative active material of the negative electrode plate comprises a mixture of graphite and silicon carbide, or a mixture of graphite and SiO₂.

20. The lithium-ion battery according to claim 12, wherein the positive electrode plate comprises a positive electrode active material, and the positive electrode active material comprises lithium cobalt oxide or lithium cobalt oxide doped or coated with two, three, or more elements selected from Al, Mg, Mn, Cr, Ti, and Zr, the chemical formula of the doped or coated lithium cobalt oxide is LiₓCo_{1-y1-y2-y3-y4}A_{y1}B_{y2}C_{y3}D_{y4}O₂, 0.95≤x≤1.05, 0.01≤y1≤0.1, 0.01≤y2≤0.1, 0≤y3≤0.1, 0≤y4≤0.1, A, B, C, D are independently selected from two or more elements among Al, Mg, Mn, Cr, Ti, Zr.
